(19) United States
(12) Patent Application Publication
(10) Pub. No.: US 2010/0309356 A1
(43) Pub. Date: Dec. 9, 2010

(54) SOLID STATE IMAGING DEVICE AND METHOD FOR DRIVING THE SAME

(75) Inventors: Isao Ihara, Kyoto (JP); Kunihiko Hara, Osaka (JP); Makoto Inagaki, Kyoto (JP); Hiroshi Kubo, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/864,674

(22) PCT Filed: Jan. 27, 2009
(86) PCT No.: PCT/JP2009/000297

§ 371 Date: Jul. 27, 2010

(30) Foreign Application Priority Data
Jan. 28, 2008 (JP) 2008-016942

(51) Int. Cl. H04N 5/335

(52) U.S. Cl. 348/300; 348/E05.091

(57) ABSTRACT

A solid state imaging device according to an aspect of the present invention includes: a pixel array (21) including pixel units arranged in rows and columns; a vertical shift register (26) which selects one of the rows of the pixel array (21); a column amplifier unit (22) including column amplifiers each of which is provided for a corresponding one of the columns and amplifies a column signal provided from the pixel unit included in the selected row; and a limiting circuit which limits an output voltage of the column amplifier to no more than a predetermined voltage that can be changed, wherein the limiting circuit changes the predetermined voltage according to switching between a normal mode and a high-sensitivity mode.

### TECHNICAL FIELD

The present invention relates to a solid state imaging device which includes a planar pixel array having pixel units arranged on a semiconductor substrate and each being a unit cell that photoelectrically converts incident light, and has a function of amplifying signals provided in a direction of columns from the pixel units, and the present invention also relates to a method for driving the solid state imaging device.

### BACKGROUND ART

In recent years, the MOS solid imaging devices are adopted more and more frequently as solid state imaging devices for use in home video cameras, digital still cameras, etc. because of their low current consumption, simple manufacturing process, preventive measures against smear troubles, and easiness in providing various drive systems represented by binning and thinning, for example.

Among various applications of the MOS solid state imaging device, one for use in a digital still camera, especially one mounted in a single-lens reflex camera, requires image quality equivalent to or higher than the CCD solid state imaging devices, and the MOS solid state imaging device therefore provides columns with an amplifying function, a correlated double sampling function, and the like function to reduce noise.

FIG. 14 is a diagram showing a structure example of an imaging system represented by a camera using a conventional MOS solid state imaging device.

The imaging system shown in FIG. 14 includes at least three blocks of a MOS solid state imaging device 100, an analog front end (hereinafter abbreviated as AFE) 200, and a timing generator (hereinafter abbreviated as TG) 300. The TG 300 may be constituted as part of the MOS solid state imaging device 100, the AFE 200, or a digital signal processor (hereinafter abbreviated as DSP) which follows the AFE 200.

In FIG. 14, the MOS solid state imaging device 100 includes a pixel array 151, a column amplifier unit 152, a correlated double sampling and signal holding circuit (hereinafter abbreviated as column CDS unit) 153, a multiplexer 154, a horizontal shift register 155, a vertical shift register 156, an output amplifier 157, and a bias current adjusting circuit 158. The AFE 200 includes a CDS circuit 159 which applies correlated double sampling to output of the MOS solid state imaging device 100, a conversion circuit (hereinafter abbreviated as A/D conversion unit) 160 which converts analog signals to digital signals, an analog gain amplifier 161, and a digital gain amplifier 162.

The pixel array 151 has multiple pixel units arranged in a matrix in a plane. Each of the pixel units includes a photodiode and a transistor. The vertical shift register 156 selects the pixel rows of the pixel array 151 one by one in sequence from a point determined by a trigger signal provided from the TG 300. Each of the pixel units included in the selected pixel row reads charges from the photodiode provided within the pixel unit and outputs a pixel signal resulting from voltage conversion performed in an FD unit amplifier provided within the pixel unit. The pixel signal is input to the column amplifier unit 152 via a vertical signal line shared in the direction of the column. The column amplifier unit 152 amplifies the pixel signal at a magnification arbitrarily set, and subsequently inputs the amplified pixel signal to the column CDS unit 153. The column CDS unit 153 applies the correlated double sampling in order to reduce variations in transistor threshold voltage which occur in each of the pixel units and cause fixed pattern noise (FPN). The amplified pixel signal provided from the column CDS unit 153 is input to the multiplexer 154. In the multiplexer 154, the pixel signal is selected on a per column basis, by the horizontal shift register, in sequence from a point determined by a trigger signal provided from the TG 300, and input to the output amplifier 157 where voltage amplification is applied, after which the resultant pixel signal is output from the imaging device.

The bias current adjusting circuit 158 controls the amount of bias current for the output amplifier 157. In the output amplifier 157, a lower f gain is obtained as the bias current decreases while a higher f gain is obtained as the bias current increases. The bias current adjusting circuit 158 selects multiple amounts of the current according to the drive mode. For example, in the case where the reduced number of pixels are used for output in a pre-shot monitor mode by thinning, and in the case where the frame rate is decreased in a high-sensitivity image capture mode, the output amplifier lowers the necessary data rate. Accordingly, in these drive modes, the bias current for the output amplifier is decreased to reduce the f gain of the output amplifier 157, thereby allowing for a reduction in random noise. It is to be noted that adjustment signals for the bias current adjusting circuit 158 are generated in the TG 300 as in the case of various drive signals for the MOS solid state imaging device 100.

The AFE 200 receives the analog video signals provided from the MOS solid state imaging device 100 and removes noise from the analog video signals in the CDS circuit 159 and then amplifies the resultant analog video signals at a given magnification in the analog gain amplifier 161. The analog video signals are then converted in the A/D conversion unit 160 into digital signals having the given number of bits, amplified at a given magnification in the digital gain amplifier 162, and then provided as digital video signals from the AFE 200.

Patent Reference 1: Japanese Unexamined Patent Application Publication No. 2002-209149

### DISCLOSURE OF INVENTION

### Problems that Invention is to Solve

The structure example of the conventional MOS solid state imaging device as shown in FIG. 14 involves a problem of noise generation attributed to power fluctuation which occurs when entering light is at the saturation level or more. To be specific, in the case where large-amplitude pixel output signals are input to the column amplifier unit 152 and the column CDS unit 153, transient current for charging and discharging load capacitance in each circuit flows through a power line and a ground line, and because of accompanying parasitic resistance and parasitic capacitance, voltage in the power line and the ground line will fluctuate. This voltage fluctuation of the power line and the ground line will appear as output offset for the pixel signals. The column amplifier unit 152 and the column CDS unit 153 process the pixel signals on a per row basis, and because whether or not the output offset is generated depends on the presence or absence of a bright subject in the corresponding row, an output image will have noise appearing in lateral strips (which will be hereinafter abbreviated as streaks) on the right and left sides of the bright subject in the horizontal direction as shown in FIG. 15

While FIG. 15 shows lower-level black streaks than the surrounding low illumination subject, white streaks may also be generated. The same kind of phenomenon occurs also in the output amplifier 157. Input of large-amplitude pixel output signals to the output amplifier 157 will cause charging and discharging of high load capacitance in inter-chip wires or the like. This causes voltage flucuation in the power line and the ground line, resulting in transverse linear noise.

The structure example of the conventional solid state imaging device as shown in FIG. 14 intends to control the f gain in the output amplifier in the last stage and therefore does not have a function of reducing fluctuation in power voltage and ground which occur in the output amplifier and the like, thus being unable to lower the levels of the streaks and the transverse linear noise.

An object of the present invention is therefore to provide a solid state imaging device which suppresses image quality deterioration by reducing noise generated in capturing an image of a bright subject, with a relatively small circuit size and a simple system, and also to provide a method for driving the solid state imaging device.

### Means to Solve the Problems

In order to solve the above problems, the solid state imaging device according to an aspect of the present invention is a solid state imaging device switchable between a normal mode and a high-sensitivity mode, including: a pixel array including pixel units arranged in rows and columns; a row selecting unit configured to select one of the rows of the pixel array; column amplifiers each of which is provided for a corresponding one of the columns and amplifies a column signal provided from the pixel unit included in the selected row; and limiting circuits each of which limits an output voltage of a corresponding one of the column amplifiers to no more than a predetermined voltage that can be changed, wherein the limiting circuit changes the predetermined voltage according to the switching between the normal mode and the high-sensitivity mode.

With this structure, even in the case of capturing an image of a bright subject, an output voltage of the column amplifier is limited, with the result that the voltage fluctuation in the power line and the ground line can be reduced and therefore the streaks and transverse linear noise can be reduced, which allows for suppression of image quality deterioration. Furthermore, because the limit level for the output voltage can be changed by changing the predetermined voltage, the noise reduction can be made to an appropriate extent depending on an image capture environment, an image capture mode, and the like.

Each of the column amplifiers may further change a gain of the column amplifier upon the switching between the normal mode and the high-sensitivity mode.

With this structure, the reduction of transverse linear noise can be optimized by combination of the limit on the output voltage with the gain change depending on an operation mode. Especially, this structure is effective to reduce the transverse linear noise in the high-sensitivity mode.

Furthermore, in the solid state imaging device, upon the switching between the modes, a gain of an amplifier circuit provided in a stage subsequent to the column amplifiers may be changed.

The limiting circuit may be configured to, in the normal mode, supply each of the column amplifiers with a first voltage as a bias voltage for controlling the output voltage of the column amplifier, and in the high-sensitivity mode, supply each of the column amplifiers with a second voltage as the bias voltage so as to limit the output voltage of the column amplifier, the second voltage being different from the first voltage.

The limiting circuit may be configured to limit the output voltage of the column amplifier supplied with the first voltage as the bias voltage to no more than the predetermined voltage, and limit the output voltage of the column amplifier supplied with the second voltage as the bias voltage to no more than a voltage lower than the predetermined voltage, and each of the column amplifiers may further set a gain of the column amplifier in the high-sensitivity mode to be higher than a gain of the column amplifier in the normal mode.

Furthermore, in the solid state imaging device, a gain of an amplifier circuit in the high-sensitivity mode may be set to be higher than a gain of the amplifier circuit in the normal mode, the amplifier circuit being provided in a stage subsequent to the column amplifiers.

The limiting circuit may include a voltage clipping circuit which is connected to an output signal line of each of the column amplifiers and clips the output voltage of the column amplifier to the predetermined voltage when the output voltage is about to exceed the predetermined voltage.

With this structure, clipping is performed such that the output voltage of the column amplifier does not exceed the predetermined voltage, and it is therefore possible to reduce the voltage fluctuation in the power line and the ground line even in the case of capturing an image of a bright subject.

Each of the column amplifiers may include a gain change circuit which changes a gain of the column amplifier.

With this structure, even in the case of capturing an image of a bright subject, it is possible to suppress the impact of the voltage fluctuation in the power line and the ground line on the output image by changing the gain of the column amplifier.

Each of the column amplifiers may include a constant current source, an amplifying transistor, an input capacitive element, and a feedback capacitive element, wherein one of a source and a drain of the amplifying transistor is connected to the constant current source and outputs the output voltage to the output signal line, the other one of the source and the drain of the amplifying transistor is grounded, the column signal is input to a gate of the amplifying transistor via the input capacitive element, one of terminals of the feedback capacitive element is connected to the gate of the amplifying transistor, and the other one of the terminals of the feedback capacitive element is connected to the output signal line.

With this structure, a so-called capacitance feedback amplifier having a gain determined based on a capacitance ratio is formed, which makes it possible to provide a small circuit having amplification characteristics with small variations.

The voltage clipping circuit may include a clipping transistor, wherein one of a source and a drain of the clipping transistor is connected to the gate of the amplifying transistor, the other one of the source and the drain of the clipping transistor is connected to the output signal line, and to a gate of the clipping transistor, a bias voltage that can be changed is input.

With this structure, the use of the clipping transistor serving as the voltage clipping circuit enables a reduction in the circuit size.

The solid state imaging device may further include a bias generation circuit which generates the bias voltage and supplies the bias voltage to the gate of the clipping transistor, wherein a level of the bias voltage is changed according to an external bias control signal.

With this structure, it is possible to easily change the predetermined voltage by changing the level of bias voltage.

The constant current source may include a first constant current source transistor and a second constant current transistor which are cascode-connected to each other, wherein a constant voltage is input to a gate of the first constant current source transistor, one of a source and a drain of the second constant current source transistor is connected to the output signal line, and a gate of the second constant current source transistor is supplied with the bias voltage.

With this structure, it is possible to control the current in the second constant current source transistor by the bias voltage.

The bias generation circuit may include a current mirror circuit including a reference circuit, a first circuit, and a second circuit, wherein the reference circuit generates a reference current for a current mirror, the first circuit is included in the current mirror together with the reference circuit, and supplies the constant voltage to the gate of the first constant current source transistor, the second circuit is included in the current mirror together with the reference circuit, and supplies the bias voltage to the gate of the second current source transistor, and the second circuit changes the bias voltage by changing a mirror ratio.

With this structure, it is possible to easily set a value of the bias voltage by changing the mirror ratio of the current mirror.

The reference circuit may include: a constant current source circuit; and a first load nMOS transistor having a drain and a gate that are shorted and a source that is ground, the drain being connected to the current source circuit, and the second circuit may include: a first pMOS transistor having a drain and a gate that are shorted and a source that is connected to a power line, the drain being connected to the gate of the clipping transistor and from which the bias voltage is provided; a first switch transistor; a first nMOS transistor having a drain connected to the drain of the first pMOS transistor via the first switch transistor, a gate connected to the drain of the first load nMOS transistor, and a source grounded; a second switch transistor; and a second nMOS transistor having a drain connected to the drain of the first pMOS transistor via the second switch transistor, a gate connected to the drain of the first load nMOS transistor, and a source connected. Furthermore, an area of the first nMOS transistor has a different size from an area of the second nMOS transistor on a semiconductor board in which the solid imaging device is formed, and the first switch transistor and the second switch transistor are controlled to change the mirror ratio, according to the bias control signal.

With this structure, it is possible to set the mirror ratio of the current mirror with high accuracy.

An area of the clipping transistor may have a substantially same size as an area of the second constant current source transistor on a semiconductor board in which the solid state imaging device is formed.

With this structure, the clipping transistor and the second constant current source transistor have the same threshold voltage, which makes it possible to prevent the second constant current source transistor from being rendered inoperative in a saturation region before the turning on of the clipping transistor.

An area of the clipping transistor may have a different size from an area of the second constant current source transistor on a semiconductor board in which the solid state imaging device is formed, and a threshold voltage for the clipping transistor may be lower than a threshold voltage for the second constant current source transistor.

With this structure, the clipping transistor and the second constant current source transistor have the same threshold voltage, which makes it possible to turn on the clipping transistor before the second constant current source transistor is rendered inoperative in a saturation region.

The gain change circuit includes a switch transistor and a capacitive element, wherein the switch transistor and the capacitive element are connected in series between the gate of the amplifying transistor and the output signal line, and the switch transistor is controlled according to an external gain control signal. With this structure, together with the feedback capacitive element, the switching transistor and the capacitive element are included in the variable capacitance circuit. This variable capacitance circuit is, together with the amplifying transistor, included in a column amplifier of capacitance feedback type. The gain of this capacitance feedback-type amplifier can be changed according to the turning on and off of the switching transistor. To be specific, when the switching transistor is off, the gain is made lower to limit the output voltage of the column amplifier. The output voltage of the column amplifier can be limited by reducing the gain and even in the case of capturing an image of a bright subject, the voltage fluctuation in the power line and the ground line can be reduced and therefore the streaks and transverse linear noise can be reduced, which allows for suppression of image quality deterioration.

The solid state imaging device may further include a noise cancellation circuit to which an output signal of the column amplifier is input; and a column pixel binning circuit which adds up signals received multiple times from the noise cancellation circuit.

With this structure, in an image capture mode in which pixel binning that adds up signals provided multiple times is performed (for example, in a monitor mode), setting the predetermined voltage to be lower and the gain to be higher will result in favorable images with less transverse linear noise.

The solid state imaging device may further include a column analog-digital conversion circuit which converts into a digital signal an analog signal provided from each of the column amplifiers.

With this structure, the signals are converted into digital values within the solid state imaging device and it is therefore possible to circumvent the impact of external noise on the signal output.

The solid state imaging device may have a normal mode and a high-sensitivity mode for capturing an image, wherein the bias generation circuit changes the bias voltage so that the predetermined voltage is smaller in the high-sensitivity mode than in the normal mode, and the gain change circuit changes the gain of the column amplifier so that the gain is higher in the high-sensitivity mode than in the normal mode.

With this structure, the reduction of transverse linear noise can be optimized depending on an operation mode.

Furthermore, the solid state imaging device according to an aspect of the present invention includes: a pixel array including pixel units arranged in rows and columns; a row selecting unit configured to select one of the rows of the pixel array; column amplifiers each of which is provided for a corresponding one of the columns and amplifies a column signal provided from the pixel unit included in the selected row; and a bias generation circuit which supplies each of the column amplifies with a bias voltage being changeable by which an operation of the column amplifier is controlled.

With this structure, it is possible to set the output characteristics of the column amplifier which are suitable to reduce transverse linear noise, by changing the bias voltage.

Each of the column amplifier may include a voltage clipping circuit which is connected to an output signal line of the column amplifier and clips the output voltage of the column amplifier to the predetermined voltage when the output voltage is about to exceed the predetermined voltage, and the predetermined voltage is determined according to the bias voltage.

With this structure, clipping is performed such that the output voltage of the column amplifier does not exceed the predetermined voltage, and it is therefore possible to reduce the voltage fluctuation in the power line and the ground line even in the case of capturing an image of a bright subject.

Each of the column amplifier may further include a gain change circuit which changes a gain of the column amplifier.

With this structure, even in the case of capturing an image of a bright subject, it is possible to reduce the voltage fluctuation in the power line and the ground line by changing the gain of the column amplifier.

The solid state imaging device may have a normal mode and a high-sensitivity mode for capturing an image, the bias generation circuit may change the bias voltage so that the predetermined voltage is smaller in the high-sensitivity mode than in the normal mode, and the gain change circuit may change the gain of the column amplifier so that the gain is higher in the high-sensitivity mode than in the normal mode.

With this structure, the reduction of transverse linear noise can be optimized depending on an operation mode. Especially, this structure is effective to reduce the transverse linear noise in the high-sensitivity mode.

Furthermore, a method for driving the solid state imaging device according to an aspect of the present invention is a method for driving a solid state imaging device including: a pixel array including pixel units arranged in rows and columns; a row selecting unit configured to select one of the rows of the pixel array; and column amplifiers each of which is provided for a corresponding one of the columns and amplifies a column signal provided from the pixel unit included in the selected row, and having a normal mode and a high-sensitivity mode for capturing an image, the method including: supplying, in the normal mode, each of the column amplifies with a first voltage as a bias voltage for controlling an output voltage of the column amplifier; and supplying, in the high-sensitivity mode, each of the column amplifiers with a second voltage as a bias voltage so that an output voltage of the column amplifier is limited, the second voltage being different from the first voltage.

With this structure, the reduction of transverse linear noise can be optimized depending on an operation mode. Especially, this structure is effective to reduce the transverse linear noise in the high-sensitivity mode.

The output voltage of the column amplifier supplied with the first bias voltage may be limited to no more than a predetermined voltage, the output voltage of the column amplifier supplied with the second bias voltage may be limited to no more than a predetermined voltage, and a gain of the column amplifier may be set to be higher in the high-sensitivity mode than in the normal mode.

With this structure, the reduction of transverse linear noise can be optimized by combination of the limit on the output voltage with the gain change depending on an operation mode. Especially, this structure is effective to reduce the transverse linear noise in the high-sensitivity mode.

Furthermore, in the method for driving a solid state imaging device, a gain of an amplifier circuit provided in a stage subsequent to the column amplifiers may be set to be higher in the high-sensitivity mode than in the normal mode.

With this structure, it is further possible to improve image quality in the high-sensitivity mode by controlling in the high-sensitivity mode the gain of the amplifier circuit disposed in a subsequent stage.

### EFFECTS OF THE INVENTION

In the solid state imaging device and the method for driving the same according to an aspect of the present invention, even in the case of capturing an image of a bright subject, the voltage fluctuation in the power line and the ground line can be reduced and therefore the streaks and transverse linear noise can be reduced, which allows for suppression of image quality deterioration. Furthermore, the noise reduction can be made to an appropriate extent depending on an image capture mode.

### BRIEF DESCRIPTION OF DRAWINGS

FIG. 1 is a block diagram showing a basic structure of a camera system including a solid state imaging device according to the first embodiment of the present invention.

FIG. 2 is an illustrative chart showing briefly showing a method of controlling a column amplifier in the solid state imaging device according to the first embodiment of the present invention.

FIG. 3 is a block diagram showing a basic structure example of the solid state imaging device according to the first embodiment of the present invention.

FIG. 4 is a block diagram showing a structure example of a pixel array and the column amplifier in the solid state imaging device according to the first embodiment of the present invention.

FIG. 5 is a chart showing operation timing of a pixel unit and the column amplifier in the solid state imaging device according to the first embodiment of the present invention.

FIG. 6 is a circuit diagram showing one example of the structure of a bias generation circuit for the column amplifier in the solid state imaging device according to the first embodiment of the present invention.

FIG. 7 is a block diagram showing a structure example of a solid state imaging device with a built-in A/D conversion unit according to the second embodiment of the present invention.

FIG. 8 is a block diagram showing a more detailed structure of the solid state imaging device shown in FIG. 7.

FIG. 9 is an illustrative chart showing the principles of operation of a column amplifier, a ramp waveform, and a comparator in the solid state imaging device with the built-in A/D conversion unit according to the second embodiment of the present invention.

FIG. 10 is an illustrative chart showing how to change the output gain of the comparator of the solid state imaging device with the built-in A/D conversion unit according to the second embodiment of the present invention.

FIG. 11 is an illustrative chart briefly showing a method of controlling the gain of the column amplifier, a limit on the output level (saturation) of the solid state imaging device, and the maximum output level (gain setting) of the ramp waveform, on each condition for capturing an image of a subject according to the second embodiment of the present invention.

FIG. 12 is a block diagram showing a structure example of a solid state imaging device according to the third embodiment of the present invention.

FIG. 13 is an illustrative chart briefly showing a method of controlling the gain of a column amplifier, a saturation limiting circuit, and an AFE gain on each image capture condition and for each drive mode according to the solid state imaging device according to the third embodiment of the present invention.

FIG. 14 is a block diagram showing a structure example of an imaging system represented by a camera using a conventional MOS solid state imaging device.

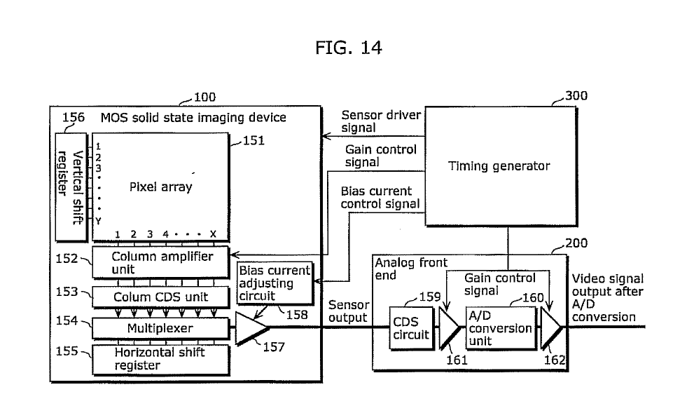

FIG. 15 is an illustrative image showing an example of generated streaks.

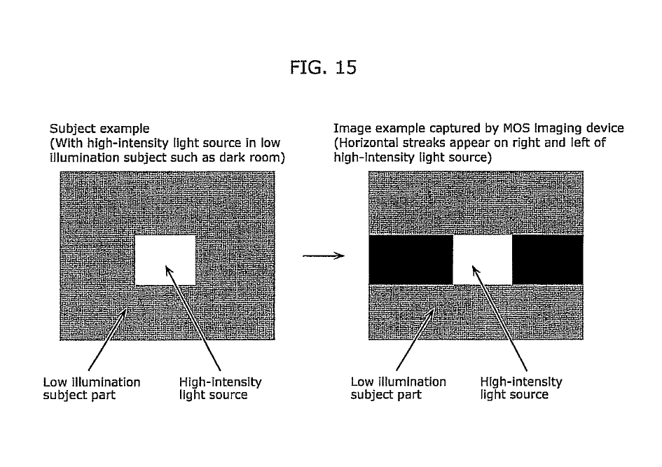

### NUMERICAL REFERENCES

1 Solid state imaging device

2 Analog front end

3 Timing generator

9 CDS circuit

10 A/D conversion unit

11 Analog amplifier

12 Digital amplifier

21 Pixel array

22 Column amplifier unit

23 Column CDS unit

24 Multiplexer

25 Output amplifier

26 Vertical shift register

27 Horizontal shift register

28 Bias generation circuit

29 Column gain control signal

30 Bias control signal

41 Photodiode

42 Transfer transistor

43 Amplifying transistor

44 Reset transistor

45 Selection transistor

50 Column amplifier input capacitance

51 First feedback capacitance

52 Second feedback capacitance

53 Current source transistor

54 Current source cascode transistor

55 Clipping transistor

56 Column amplifier reset transistor

57 Source-grounded amplifying transistor

58 Control transistor

61 Voltage clipping circuit

62 Variable feedback capacitance circuit

63 Gain change circuit

71 Constant voltage Vcol setting transistor

72 Constant voltage Vcas setting transistor

73 Current setting transistor

74 to 77 Source-grounded transistor

78 First selection transistor

79 Second selection transistor

210 Pixel unit

220 Column amplifier

230 CDS circuit

### BEST MODE FOR CARRYING OUT THE INVENTION

### First Embodiment

A solid state imaging device according to the first embodiment is characterized as including a limiting circuit for limiting the output voltage of the column amplifier to no more than a predetermined voltage that can be changed. A voltage clipping circuit is connected to an output signal line of the column amplifier and clips the output voltage of the column amplifier to the predetermined voltage when the output voltage is about to exceed the predetermined voltage. A gain change circuit changes the gain of the column amplifier including the gain change circuit for changing the gain of the column amplifier. With this, even in the case of capturing an image of a bright subject, voltage fluctuation in a power line and a ground line can be reduced and therefore streaks and transverse linear noise can be reduced, which allows for suppression of image quality deterioration. Furthermore, because the limit level for the output voltage can be changed by changing the predetermined voltage, the noise reduction can be made to an appropriate extent depending on an image capture environment, an image capture mode, and the like.

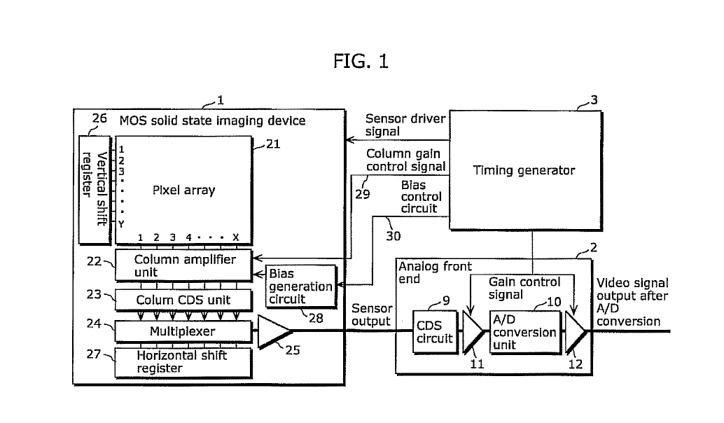

The first embodiment of the present invention is described with reference to FIGS. 1 to 6. FIG. 1 is a basic configuration diagram of a camera system (imaging device) including a solid state imaging device according to the first embodiment of the present invention.

FIG. 1 shows a basic structure of a camera system including a solid state imaging device according to the first embodiment of the present invention. The camera system according to an implementation of the present invention shown in FIG. 1 includes, as the minimum basic structure, a solid state imaging device 1, an analog front end (hereinafter abbreviated as AFE) 2, and a timing generator (hereinafter abbreviated as TG) 3. The solid state imaging device 1 includes a pixel array 21, a column amplifier unit 22, a column CDS unit 23, a multiplexer 24, an output amplifier 25, a vertical shift register 26, a horizontal shift register 27, and a bias generation circuit 28. The AFE 2 includes a CDS circuit 9 which applies correlated double sampling to output signals from the solid state imaging device 1, a converter (hereinafter abbreviated as A/D conversion unit) 10 which converts analog signals to digital signals, an analog amplifier 11, and a digital amplifier 12. The TG 3 supplies a bias control signal 30 to the bias generation circuit 28 at the same time as the TG 3 supplies a drive signal to the solid state imaging device 1. At the same time, the TG 3 adjusts the gain of the analog amplifier 11 and the gain of the digital amplifier 12 in the AFE 2.

In the solid state imaging device 1, a pixel signal in a row selected by the vertical shift register 26 is read out from the pixel array 21 and input to the column amplifier unit 22. In the column amplifier unit 22, the signal is amplified according to the gain set by a column gain control signal 29 provided from the TG 3. Furthermore, the output amplitude of the column amplifier unit 22 is limited according to the bias voltage supplied from the bias generation circuit 28. The output of the column amplifier unit 22 is input to the column CDS unit 23. The column CDS unit 23 cancels a noise component generated due to variations of transistors included in the pixel array 21 and holds the pixel signals included in one row. The signals held by the column CDS unit 23 are selected one by one in sequence by the horizontal shift register 27 and amplified by the output amplifier. 25 and thereafter provided to outside of the solid state imaging device 1. The video signals output from the solid state imaging device 1 are then input to the AFE 2 where the video signals are then treated with the CDS and the A/D conversion, and then output from the AFE 2 in form of digital video signals having the specified number of bits. It is to be noted that upon switching between a normal mode and a high-sensitivity mode, the gain of an amplifier circuit (output amplifier 25) disposed in a subsequent stage to the column amplifier unit 22 may be changed. That is, the gain of the output amplifier 25 may be changed according to the column gain control signal 29.

From the conventional example where the gain of the output amplifier in the last stage is limited, the solid state imaging device 1 according to the first embodiment of the present invention is widely different in that the gain of the column amplifier unit 22 and the amplitude of the output signals are limited.

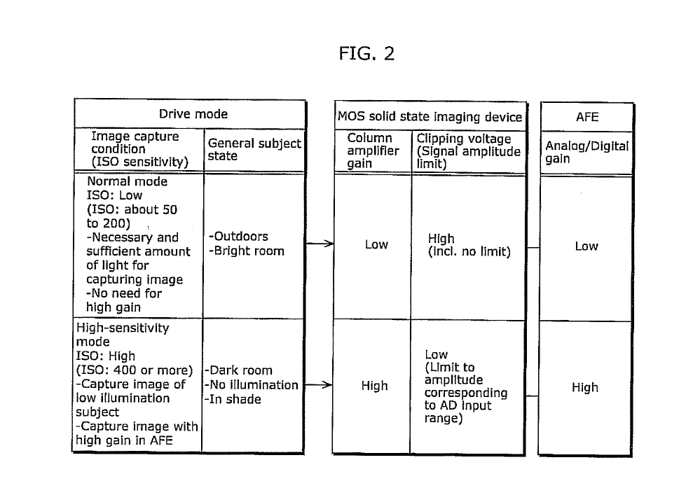

Next, FIG. 2 briefly shows a method of controlling the column amplifier unit according to the first embodiment of the present invention.

As shown in FIG. 2, the drive mode includes at least two modes: the normal mode and the high-sensitivity mode. Using the film exposure index set by the international organization for standardization (ISO), the normal mode and the high-sensitivity mode are explained. The normal mode is a mode with a low ISO sensitivity in the order of ISO 50 to 200 while the high-sensitivity mode is a mode with a high ISO sensitivity of ISO 400 or more.

When capturing an image in the normal mode, because a subject has a sufficient amount of light and a saturation level needs to be high enough, the signal amplitude is not limited in the column amplifier unit of the solid state imaging device. In addition, the pixel signal output is not amplified or amplified with a low gain in the column amplifier unit 22 of the solid state imaging device and the analog amplifier 11 and the digital amplifier 12 of the AFE 2. Because the gain is thus low, the amount of noise attributed to power fluctuation is negligibly small with respect to the magnitude of signal, which therefore causes no problem.

Next, when capturing an image in the high-sensitivity mode, because a subject is dark with a small amount of light, the signal output is amplified with an increased gain of the column amplifier unit 22 of the solid state imaging device and with increased gains of the analog amplifier 11 and the digital amplifier 12 of the AFE 2, so as to increase the contrast in low illumination. The signal amplitude is however limited to the level corresponding to the input range of the A/D conversion unit by changing the bias voltage in the column amplifier unit 22. This reduces the noise (streaks and transverse linear noise) attributed to power fluctuation in the column amplifier unit 22, the column CDS unit 23, and the output amplifier 25. In this drive mode, the gain is set to be high in the AFE 2, but the above-mentioned noise reduction brings about an effect of preventing the quality of images at the output of the solid state imaging device 1 from deteriorating.

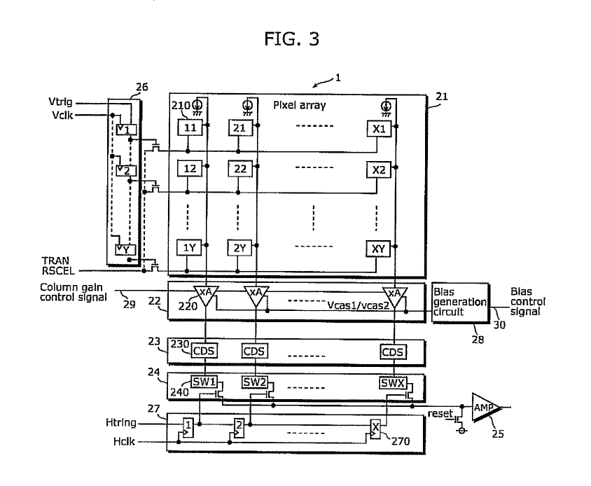

Next, FIGS. 3 to 6 show a specific structure example of the solid state imaging device according to the first embodiment of the present invention.

FIG. 3 is a block diagram showing a more detailed basic structure of the solid state imaging device according to the first embodiment of the present invention.

In FIG. 3, the pixel array 21 includes multiple pixel units 210 arranged in rows and columns. The column amplifier unit 22 includes multiple column amplifiers 220 each of which is provided for a corresponding one of the columns and amplifies column signals output from the pixel unit 210 included in the row selected by the vertical shift register 26. The column CDS unit 23 includes multiple CDS circuits 230 each of which is provided for a corresponding one of the columns and applies correlated double sampling to output of the column amplifier unit 22. The multiplexer 24 includes multiple switch circuits each of which is provided for a corresponding one of the columns, and provides to the output amplifier 25 the output signal of the CDS circuit 230 included in the column selected by the horizontal shift register 27. The vertical shift register 26 selects a row of the pixel array 21. The bias generation circuit 28 is controlled according to the bias control signal 30 given from the TG 3 to generate a bias voltage, and inputs the bias voltage to each row of the column amplifiers 220, thereby changing the limit level for amplitude of the output signal of the column amplifiers 220. The gain of each of the column amplifiers 220 is changed in at least two stages: high and low, according to the column gain control signal 29 provided from the TG 3.

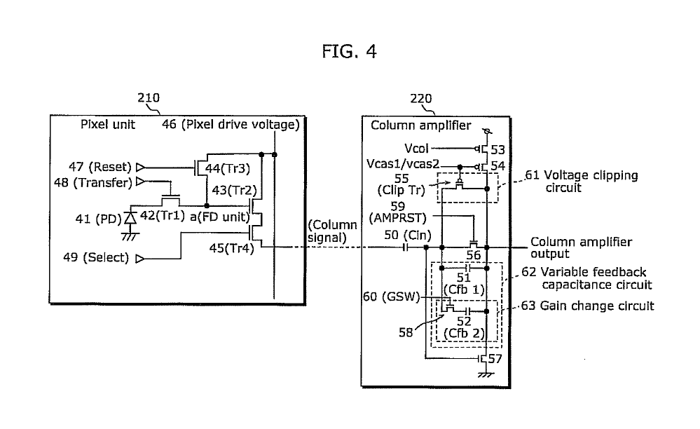

FIG. 4 is a circuit diagram showing more detailed structures of one of the pixel units 210 and one of the column amplifiers 220.

The pixel unit 210 includes a photodiode 41, a transfer transistor 42, an amplifying transistor 43, a reset transistor 44, and a selection transistor 45. The reference numeral 46 denotes a pixel drive voltage, 47 denotes a pixel reset signal, 48 denotes a pixel transfer signal, and 49 denotes a pixel selection signal.

The column amplifier 220 includes a column amplifier input capacitance (hereinafter referred to as an input capacitance) 50, a first feedback capacitance 51, a second feedback capacitance 52, constant current sources (a current source transistor 53 and a current source cascade (or shield) transistor 54), a clipping transistor 55, a column amplifier reset transistor 56, a source-grounded amplifying transistor 57, and a control transistor 58 for the second feedback capacitance 52. The reference numeral 59 denotes a reset signal AMPRST for the column amplifier and 60 denotes a control signal GSW for the control transistor for the second feedback capacitance 52.

The column signal provided to the column amplifier 220 enters the gate of the source-grounded amplifying transistor 57 via the column amplifier input capacitance 50. The drain of the source-grounded amplifying transistor 57 is connected to the constant current source (the current source cascode transistor 54). From this drain, the amplified output voltage is provided to the output signal line.

The column amplifier 220 includes a voltage clipping circuit 61 and a variable feedback capacitance circuit 62.

The voltage clipping circuit 61 includes the clipping transistor 55. One of the source and the drain of the clipping transistor 55 is connected to the gate of the amplifying transistor, and the other one of the source and the drain of the clipping transistor 55 is connected to the output signal line.

To the gate of the clipping transistor 55, a bias voltage that can be changed is input from the bias generation circuit 28. The bias voltage is one of at least two constant voltages: Vcas 1 and Vcas 2.

The variable feedback capacitance circuit 62 includes the first feedback capacitance 51, the second feedback capacitance 52, and the control transistor 58 functioning as a switch. Of these components, the second feedback capacitance 52 and the control transistor 58 constitute a gain change circuit 63 which changes the gain of the column amplifier.

In the pixel unit 210 of FIG. 4, the photodiode 51 is connected to a gate terminal a (hereinafter abbreviated as FD unit) of the amplifying transistor 43 via the transfer transistor 42. The transfer transistor 42 is controlled according to the pixel transfer signal 48 and thereby transfers pixel signal charges to the FD unit. The FD unit is connected to the pixel drive voltage 46 via the reset transistor 44 and controlled according to the reset signal 47. The amplifying transistor 43 is included in an external current source (not shown in FIG. 4) and in a source follower amplifier, and outputs a signal according to the FD voltage, and via the selection transistor 45 selected according to the selection signal 49, the amplifying transistor 43 outputs to one of the terminals of the column amplifier input capacitance 50 the output signal provided from the pixel.

The column amplifier 220 of FIG. 4 includes the column amplifier input capacitance 50, the first and the second feedback capacitances 51 and 52, the source-grounded amplifying transistor 57, the current source transistor 53, and the current source cascode transistor 54, and is thus one example of the capacitance feedback amplifier.

The clipping transistor 55, which is one example of the voltage clipping circuit according to an implementation of the present invention, is a MOS transistor which limits the maximum output voltage of the column amplifier 220. The column amplifier input capacitance 50 has one terminal connected to the vertical signal line. The first and the second feedback capacitances 51 and 52 are provided between the other terminal of the column amplifier input capacitance 50 and the output terminal of the column amplifier circuit. The second feedback capacitance 52, which is connected via the control transistor 58, can be disconnected from and connected to the feedback loop of the amplifier by controlling the control transistor 58 according to the control signal GSW 60. The current source cascode transistor 54 has a drain connected to the output of the column amplifier circuit. The current source transistor 53 is cascode-connected to the current source cascode transistor 54 and has a drain connected to the source of the current source cascode transistor 54 and a gate connected to the constant voltage Vcol. The source-grounded amplifying transistor 57 has a drain connected to the output of the column amplifier circuit and a source grounded. The clipping transistor 55 has a source connected to the output of the column amplifier circuit, a drain connected to the gate of the source-grounded amplifying transistor 57, and a gate connected to the signal line Vcas. To the gates of the current source transistor 53 and the current source cascode transistor 54, the constant voltages Vcol and Vcas are applied respectively so that both of these transistors operate in the saturation region. To the gate of the clipping transistor 55, the constant voltage Vcas connected to the gate of the current source cascode transistor 54 is applied. A closed loop gain Ac of this column amplifier circuit is represented by (Expression 1) using a parasitic capacitance Cp of the gate of the source-grounded amplifying transistor 57 and an open loop gain AO.

$$\begin{matrix}[ Math . 1 ] & \\ Ac = \frac{Cin}{( Cfb + \frac{Cin + Cfb + Cp}{Ao} )} & ( Expression 1 )\end{matrix}$$

Assuming that the open loop gain AO is sufficiently large (approximately 500 or more), the closed gain Ac is represented by (Expression 2).

$$\begin{matrix}[ Math . 2 ] & \\ Ac = \frac{Cin}{Cfb} & ( Expression 2 )\end{matrix}$$

Changing the control signal GSW 60 causes a change in the size of the feedback capacitance and results in a change in the amplifier gain Ac. To be specific, with the control signal GSW=high, Ac will be small because (Cfb=Cfb2+Cfb2) while with GSW=low, Ac will be large because (Cfb=Cfb1).

In sum, the imaging device or solid state imaging device according to the first embodiment of the present invention is characterized in that the column amplifier is a capacitance feedback amplifier.

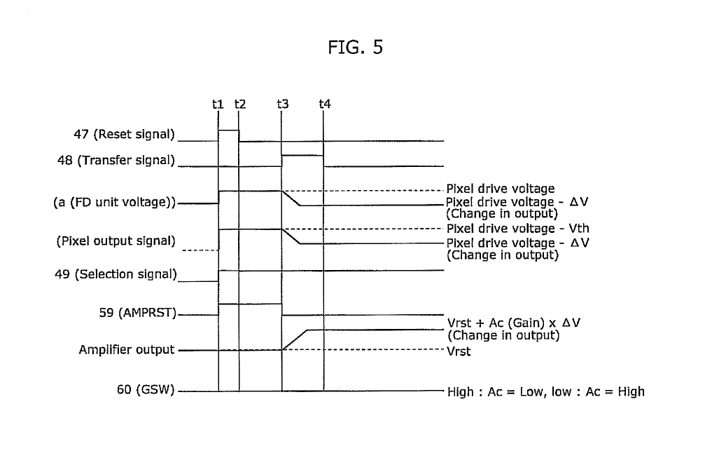

Next, with reference to the timing chart of FIG. 5, a method for driving the imaging device or slid state imaging device according to the first embodiment of the present invention (especially, circuit operation of the pixel unit 210 and the column amplifier 220 in FIG. 4) is described.

First, from time t1 to t2, the reset signal 47 becomes high and the FE unit is reset to “pixel drive voltage” level.

Next, during a period from time t3 to t4, the pixel transfer signal 48 becomes high, which causes the pixel charge signals accumulated in the photodiode 41 to be transferred to the FD unit via the transfer transistor 42, with the result that the FD unit changes to (“pixel drive voltage”—a change ΔV in the pixel signals). The amplifying transistor 43, which is included in the external current source (not shown in FIG. 5) and in the source follower amplifier, changes from the voltage of the FD unit (“pixel drive voltage”—ΔV) by Vth of the transistor and outputs the output signal provided from the pixel, to one of the terminals of the column amplifier input capacitance 50 via the selection transistor 45 controlled according to high input of the selection signal 49. The column amplifier 220 is at the Vrst level during the period from time t1 to t3 as controlled by the column amplifier reset signal AMPRST 59, and upon releasing of the AMPRST 59 to “low”, the pixel signal ΔV is amplified by a factor of the closed loop gain Ac given by the above (Expression 2) and then output.

Next, operation of the clipping transistor to limit output is described.

First, when the amplifier is reset, the input and output of the source-grounded amplifier are shorted, with the result that the voltage Vrst of the amplifier is so low as approximately 1 V. At this time, the clipping transistor 55 is OFF.

Next, after resetting, an increase in the input (a decrease in the voltage) of the amplifier will cause little change in the input of the source-grounded amplifier but cause an increase in the output thereof. When the voltage at the output exceeds Vcas-Vtp, the clipping transistor 55 is turned on, which causes an increase in the input of the source-grounded amplifier and stops the increase in the output thereof. On the other hand, in order to maintain the constant current operation of the cascode current source, the output voltage needs to be equal to or lower than (gate voltage)—Vtp.

As above, the constant current operation can be ensured by the clipping transistor 55 when the same Vcas is supplied to the column amplifiers 220. Thus, the output amplitude of the amplifier is limited by the clipping transistor 55 and its limit level is controlled by the bias voltage supplied from the bias generation circuit.

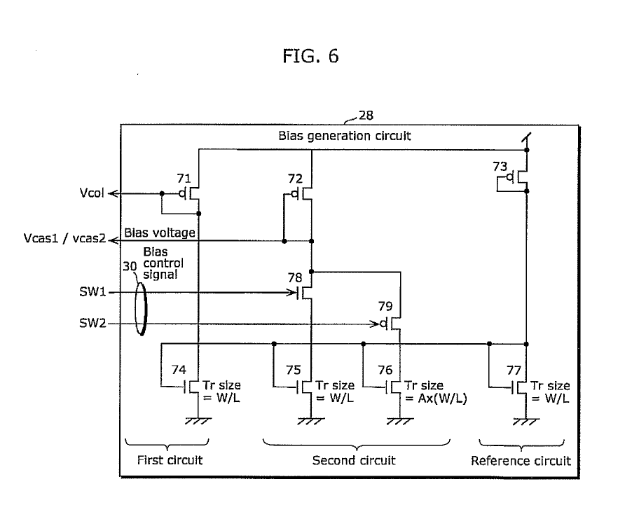

FIG. 6 is a circuit diagram showing a detailed structure of the bias generation circuit 28 according to the first embodiment of the present invention.

In FIG. 6, the bias generation circuit 28 is a current mirror circuit including a reference circuit, a first circuit, and a second circuit. The reference circuit generates a reference current for the current mirror. The first circuit is included in the current mirror together with the reference circuit, and supplies a constant voltage Vcol to the gate of the current source transistor 53. The second circuit is included in the current mirror together with the reference circuit, and supplies the bias voltage Vcas 1 or Vcas 2 to the gate of the current source cascode transistor. This second circuit can change the above bias voltage by changing the mirror ratio.

The reference circuit includes a current setting transistor 73 functioning as a constant current source circuit, and a source-grounded transistor 77 (the first load nMOS transistor). The source-grounded transistor 77 has a drain connected to the current setting transistor 73 and has its drain and gate shorted. This allows a reference current to flow between the current setting transistor 73 and the source-grounded transistor 77.

The first circuit includes a constant voltage Vcol setting transistor 71 and a source-grounded transistor 74.

The second circuit includes a constant voltage Vcas setting transistor 72 (first pMOS transistor), a first selection transistor 78 (first switch transistor), a second selection transistor 79 (second switch transistor), a source-grounded transistor 75 (first nMOS transistor), and a source-grounded transistor 76 (second nMOS transistor).

In FIG. 6, 71 denotes a constant voltage Vcol setting transistor, 72 denotes a constant voltage Vcas setting transistor, 73 denotes a current setting transistor, 74 to 77 denote source-grounded transistors, 78 denotes the first selection transistor, and 79 denotes the second selection transistor. The constant voltage Vcol setting transistor □□ has a source connected to a power and supplies the constant voltage Vcol from its drain, and in addition, it is connected to the gate. The constant voltage Vcas setting transistor 72 also has a source connected to a power source and supplies the voltage Vcas from its drain, and at the same time, it is connected to the gate. The constant voltage Vcol setting transistor 71 and the constant voltage Vcas setting transistor 72 are each connected to the source-grounded transistors 74, 75, and 76.

The levels of constant voltages Vcol and Vcas are each controlled by the source-grounded transistors 74, 75 and 76. The constant voltage Vcos setting transistor 71 has its gate terminal connected to the gate terminal of the current source transistor 53 of FIG. 4 and is connected to the source-grounded transistor 74, thereby forming the mirror circuit. By setting the size of the source-grounded transistor, it is possible to set the amount of current flowing through the current source transistor 53 of the column amplifier 220. The constant voltage Vcas setting transistor 72 has its gate connected to the gate of the current source cascode transistor 54 of the column amplifier 220 and is connected to the source-grounded transistors 75 and 76, thereby forming the mirror circuit. By setting the size of the source-grounded transistors 75 and 76, it is possible to set the amount of current flowing through the constant voltage Vcas setting transistor 72, that is, possible to set its drain potential, namely, the voltage Vcas. Furthermore, the source-grounded transistors 75 and 76 are connected to the drain of the constant voltage Vcas setting transistor 72 via the respective selection transistors 78 and 79. The respective gates of the selection transistors are connected to SW1 and SW2, and can be selectively connected to and disconnected from the source-grounded transistors 75 and 76 by setting the SW1 and the SW2.

With the above structure, the imaging device or solid state imaging device according to the first embodiment of the present invention is capable of selecting different values for the voltage Vcas by setting different sizes for the source-grounded transistor 75 and 76 connected to the constant voltage Vcas setting transistor 72 via the SW1 and the SW2. This change in the voltage Vcas allows for a change in the gate voltage of the clipping transistor 55 in the column amplifier 220 shown in FIG. 4 and thereby allows for a change in the output limit level of the column amplifier 220.

It is to be noted that the bias generation circuit is mounted within the solid state imaging device. When the column amplifier 220 and the bias generation circuit shares at least one of the power source and the ground, it is possible to obtain stable bias voltage as compared to the case where the bias generation circuit is disposed outside the device.

Thus, the imaging device or solid state imaging device according to the first embodiment of the present invention shown in FIGS. 3 to 6 is capable of changing the gain and output limit level of the column amplifier 220. By applying this solid state imaging device to the camera system shown in FIG. 1 and controlling as shown in FIG. 2 according to the image capture condition, it is possible to reduce noise attributed to power fluctuation.

### Second Embodiment

The second embodiment of the present invention is an implementation example where the A/D conversion unit and the TG are built in the solid state imaging device.

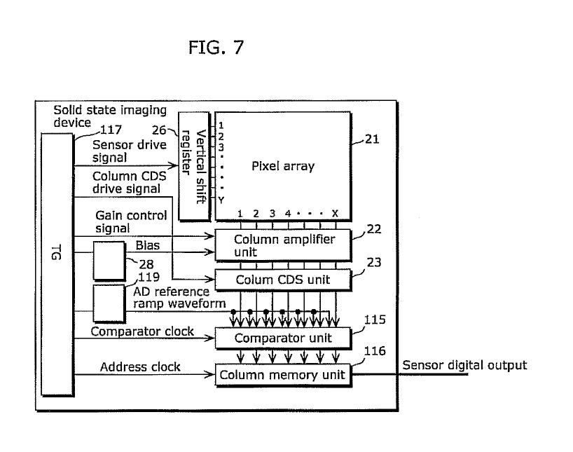

FIG. 7 is a block diagram showing a structure example of the solid state imaging device with the built-in A/D conversion unit according to the second embodiment.

The solid state imaging device of FIG. 7 is different from that of FIG. 1 in that the multiplexer 24 and the horizontal shift register 27 are not present, a ramp waveform generation circuit 119, a comparator unit 115, and a column memory 116 are added, and the timing generator (hereinafter abbreviated as TG) 117 is built in. In the following, differences are mainly explained while explanations of the same points are omitted.

According to the solid state imaging device drive signal provided from the TG 117, the pixel analog signals are output on a per row basis from the pixel array 21 and input to the column amplifier unit 22. The analog signals are amplified in the column amplifier unit 22 and processed with noise cancellation in the column CDS unit 23, thereafter being input to the comparator unit 115. The comparator unit 115 compares the signals with an A/D conversion reference ramp waveform and converts the signals into corresponding digital output, then outputting digital pixel signals to the column memory 116.

By reading out data from this column memory 116 through the serial communication, digital output is retrieved from the solid state imaging device. It is to be noted that as in the case of the first embodiment, it is possible to adjust the gain of the column amplifier unit 22 and the output limit level of the column amplifier unit 22 that is determined according to the bias voltage of the bias generation circuit. Furthermore, the gain can be changed even in the A/D conversion.

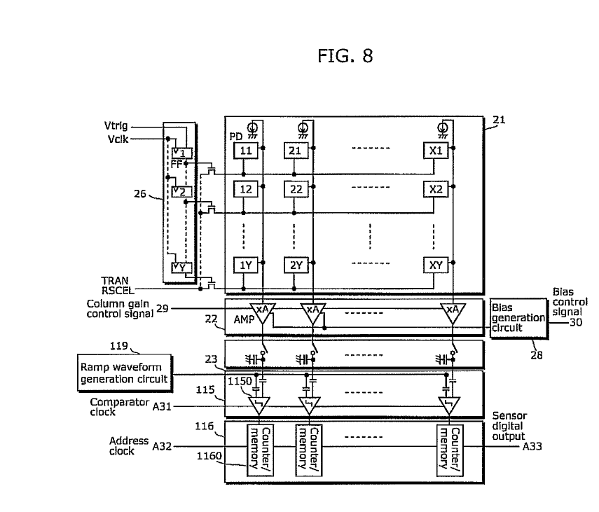

FIG. 8 is a block diagram showing a more detailed structure of the solid state imaging device shown in FIG. 7. The solid state imaging device of FIG. 8 is different from that of FIG. 3 in that the multiplexer 24 and the horizontal shift register 27 are not present, and the ramp waveform generation circuit 119, the comparator unit 115, and the column memory 116 are added. In the following, differences are explained mainly while explanations of the same points are omitted.

The comparator unit 115 includes comparators 1150 each of which is provided for a corresponding one of the columns of the pixel array 21. Each of the comparators 1150 compares the column signal with the ramp waveform, and upon matching, the comparator 1150 reverses its output.

The column memory 116 includes unit counter memories 1160 each of which is provided for a corresponding one of the columns of the pixel array 21. Each of the unit counter memories 1160 takes time (clock counts) from the start of the output of the ramp waveform until the reverse of the output of a corresponding one of the comparators 1150, and stores the resultant in form of a digital value corresponding to the analog pixel signal.

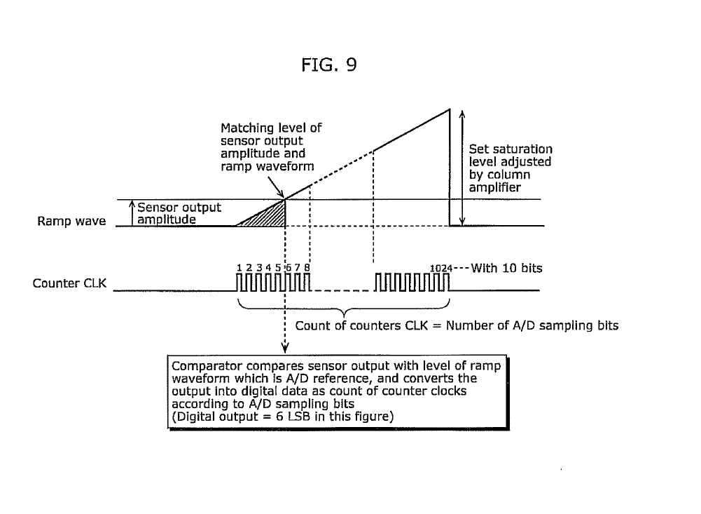

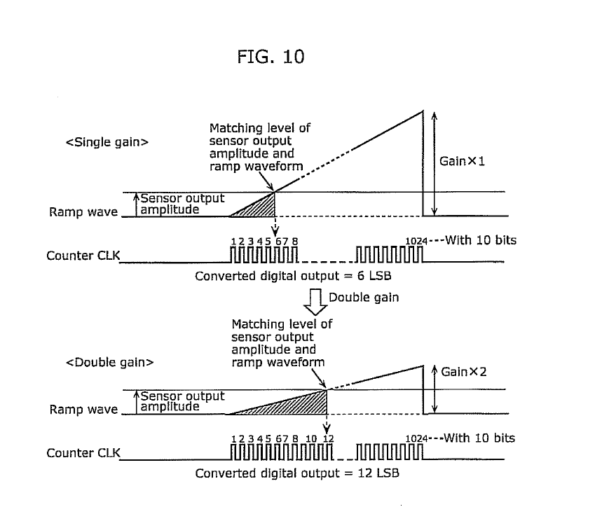

Next, the A/D conversion operation using the ramp waveform generation circuit 119 and the comparator unit 115 is described in detail with reference to FIGS. 9 and 10.

First, FIG. 9 shows the principles of the A/D conversion operation.

With reference to FIG. 9, the analog signal provided from the column CDS circuit and the initial voltage of the ramp waveform generation circuit are input to the comparator unit 115. Next, the output of the ramp waveform generation circuit is increased linearly and, in synchronization with the output of the ramp waveform, the counter clock will be output. The count of counter clocks is adjusted according to the number of sampling bits for use in the A/D conversion. The output level of the analog signal is compared with the output level of the ramp waveform in each of the comparators 1150 and until the output level of the analog signal becomes equal to the output level of the ramp waveform, the counter clocks are counted. The resultant count will be output as A/D converted digital signal. In the case of FIG. 9, as an example, the count of counter clocks is represented as 10 bits=1024 counts, and the count of counter clocks taken until the output level of the ramp waveform becomes equal to the analog output level is 6 LSB. In this case, the digital output level of the solid state imaging device is 6 LSB out of 1024 LSB.

Next, FIG. 10 shows gain adjustment operation in the A/D conversion. It is to be noted that in FIG. 10, as in the case of FIG. 9, assuming as an example that the number of sampling bits in the A/D conversion is 10 bits, the converted digital output is 6 LSB with respect to the maximum output level of the ramp waveform set with a single gain.

Next, when a double gain is set, the maximum output level of the ramp waveform is adjusted to be half. Subsequently, as in the case of the single gain, the counter clocks are counted until the output level of the ramp waveform becomes equal to the analog output level, the gradient will be half because the maximum output level of the ramp waveform is half, and the count of counter clocks taken until the output level of the ramp waveform becomes equal to the analog output level will be 12 LSB. This is equivalent to a case with a double gain in the A/D conversion. Such an adjustment to the amplitude of the ramp waveform thus enables an adjustment to the gain at the time of the A/D conversion.

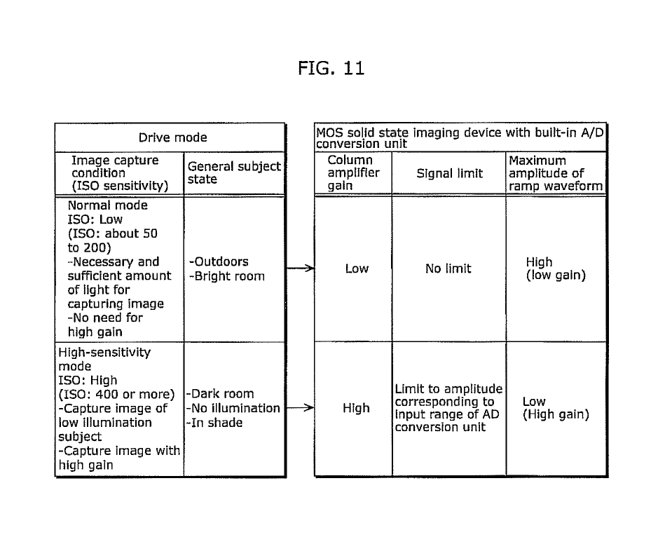

The following describes the column amplifier gain, the output level (saturation) limit for amplifier, and the maximum output level of the ramp waveform (gain setting) for each drive mode in the second embodiment of the present invention with reference to FIG. 11.

As shown in FIG. 11, the image capture mode includes a normal mode in the order of ISO 50 to 200 and a high-sensitivity mode of ISO 400 or more.

When capturing an image in the normal mode, because a subject has a sufficient amount of light and a saturation level needs to be high enough, the gain of the column amplifier 220 is set to be low and in addition, the amplitude of the ramp waveform is adjusted to be large so that the gain in the A/D conversion becomes low. Moreover, the bias voltage is set so that the output of the column amplifier 220 is not limited. In this case, the gain of the entire circuit system is so low that the amount of noise attributed to power fluctuation is negligibly small with respect to the signals and therefore causes no problem. On the other hand, when capturing an image in the high-sensitivity mode, because a subject is dark with a small amount of light, the gain of the column amplifier 220 is set to be high and the signal from a dark part is amplified so as to increase the contrast in low illumination. In addition, the amplitude of the ramp waveform is set to be small so that the gain in the A/D conversion becomes high. In this case, if the dark part of the subject includes a high-intensity light source, the output level will far exceed the input range of the A/D conversion, which makes the above power fluctuation more likely to occur, and furthermore because the gain is set to be high, the noise attributed power fluctuation which will also be amplified becomes prominent.

For this reason, the output of the bias generation circuit 28 is appropriately adjusted and the output of the column amplifier unit 22 is limited so that the output of the column CDS unit 23 becomes equivalent to the input range of the A/D conversion. By so doing, even in the case of the second embodiment of the present invention, it is possible to reduce the noise attributed to power fluctuation.

It is to be noted that while the TG unit is also built in the structure in the second embodiment of the present invention, the same effects can be obtained even with a structure in which the TG unit is disposed separately from the solid state imaging device with the built-in A/D conversion unit and thus provides the solid state imaging device drive signal, various clocks, column amplifier gain signal, ramp waveform control signal and control signal for the bias generation circuit.

Furthermore, while the column CDS circuit is disposed between the column amplifier unit 22 and the comparator unit 115 in the solid state imaging device with the built-in A/D conversion unit in the second embodiment of the present invention, the same effects can be obtained, for reduction in the noise attributed to power fluctuation, even with a structure in which a level of noise clamp that serves as a reference at the time of CDS is also compared with the ramp waveform and thus digitalized and the pixel signal is thereafter digitalized and treated with the column CDS process in the digital circuit.

### Third Embodiment

The third embodiment of the present invention is an implementation example where the solid state imaging device is provided with a function of vertical binning (adding) of pixels on a per column basis (for example, the first row plus the second row, the third row plus the fourth row, and the like sequential addition).

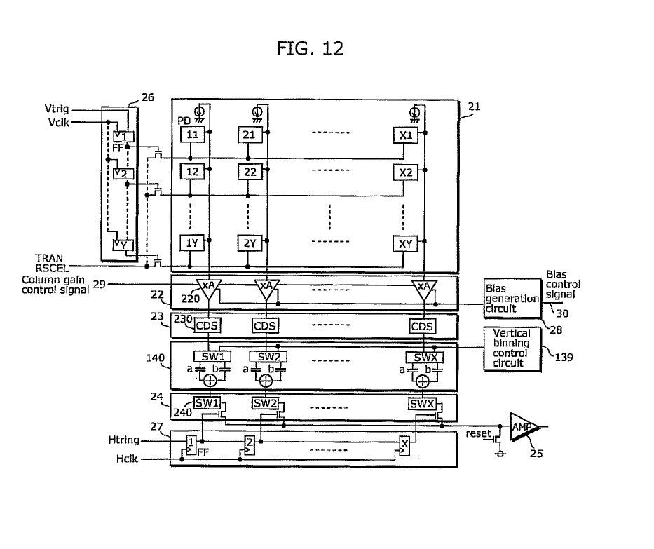

FIG. 12 is a block diagram showing a structure example of a solid state imaging device according to the third embodiment of the present invention.

The solid state imaging device of FIG. 12 is different from that of FIG. 3 in that a vertical binning control circuit 139 and a pixel binning control circuit 140 are added. In the following, differences are explained mainly while explanations of the same points are omitted.

The vertical binning control circuit 139 controls the pixel binning circuit 140 to combine multiple pixel signals included in the same column but in different rows. For example, this pixel binning is utilized to display a minified image on a monitor in the monitor mode (moving image capture mode).

The pixel binning circuit 140 includes multiple binning circuits each of which is provided for a corresponding one of the columns of the pixel array 21. Each of the binning circuits accumulates pixel signals which are input multiple times. The entire structure of the camera system is the same as that of FIG. 1.

Furthermore, the charges accumulated in the pixel array 21 are input as pixel signals to the column amplifiers 220 in the corresponding columns row by row, by scanning the vertical shift register 26. The bias generation circuit 28 is controlled according to the bias control signal 30 given from the TG to generate a bias voltage, and inputs the bias voltage to each column of the column amplifiers 220, thereby changing the limit level for amplitude of the output signal. The gain of each of the column amplifiers 220 is changed in at least two stages: high and low, according to the column gain control signal 29 provided from the TG. The pixel signals are amplified by the column amplifier 220 and thereafter provided to the column CDS unit 23 where the CDS process is applied to the pixel signals. The CDS-processed pixel signals are then input to the pixel binning circuit 140. The pixel binning signal 140 is controlled by the vertical binning control circuit 139 and according to the control signal input from the vertical binning control signal 139, the pixel signals are distributed into a capacitance a or a capacitance b and then are binned in or pass through a subsequent adder circuit, thereafter being output. For example, without binning the pixels, the switch keeps on selecting the capacitance a or the capacitance b, with the result that the pixel signals pass through the adder circuit and then are provided to the multiplexer 24. In a pixel adding mode, the vertical binning circuit distributes the pixels signals into the capacitance a or the capacitance b on a per row basis, and both of the distributed pixel signals are then subject to the addition in the adder circuit in the subsequent stage and output to the multiplexer 24. The output of the pixel signals input to the multiplexer 24 is selected in sequence by the horizontal shift register and output from the solid state imaging device via the output amplifier 25. The video signals output from the solid state imaging device are input to the AFE where the video signals are then treated with the CDS and the A/D conversion, and then output from the AFE in form of digital video signals having the specified number of bits.

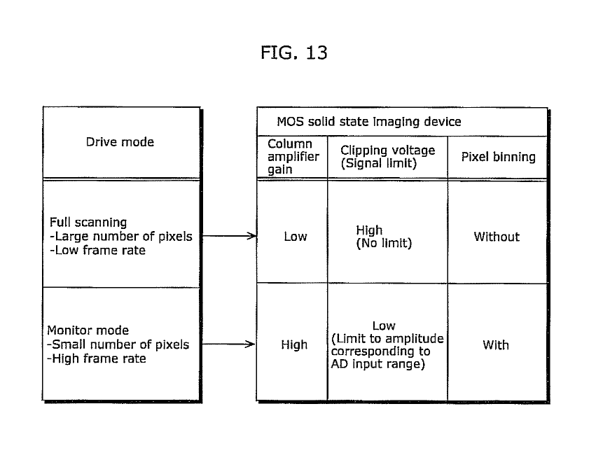

FIG. 13 shows settings of the column amplifier gain and the column output limit for each drive mode in the solid state imaging device according to the third embodiment of the present invention.

As shown in FIG. 13, the drive mode includes a full-scanning mode, which is normal and involves no pixel binning, and a monitor mode, which involves pixel binning. In the monitor mode, the number of output pixels is reduced in order to increase the frame rate. To reduce pixels, there are two methods: pixel binning and pixel thinning, and the pixel binning has an advantage that moire is less likely generated.

In the full-scanning mode, because the frame rage is low, an accumulation time can be made long, so that a large signal can be obtained. The gain of the column amplifier 220 is therefore set to be low. Furthermore, because no pixel binning is performed, there is no gain resulting from binning and the output of the column amplifier 220 corresponding to the input range of the A/D conversion unit is large. Accordingly, no limit is set on the output (a bias voltage with no output limit is set). In this case, because the gain of the circuit is low, the amount of noise attributed to power fluctuation is negligibly small with respect to the signals and therefore causes no problem.

Next, in the monitor mode, because the solid state imaging device is driven with a high frame rate, the accumulation time will be short, which results in a small signal. The column amplifier gain is therefore set to be high. Moreover, the pixel binning is performed, and a gain resulting from binning of two pixels (in this example, a double gain) is generated. This means that the amplitude of the output of the column amplifier 220 corresponding to the input range of the A/D conversion unit is a half of that in the full-scanning mode. Accordingly, adjusting the bias voltage of the column amplifier 220 and limiting the output to a half will allow for a reduction in the noise attributed to power fluctuation.

It is to be noted that while the above description shows, as an example, the solid state imaging device according to the third embodiment of the present invention with a structure in which the vertical pixel binning is performed for two rows after the column CDS, the same effects can be obtained even with a structure in which vertical binning of two or more pixels is performed, a structure in which the vertical pixel binning is performed before the column CDS, or a structure in which multiple pixels are binned in the horizontal direction, as long as these structures use a method of imposing a saturation limit on such a signal output as to exceed the saturation level or the A/D input range as a result of the pixel binning.

Furthermore, while the above description shows an example where the column amplifier 220 includes the source-grounded amplifying transistor in each of the above embodiments, a drain-grounded amplifying transistor (so-called a source follower) may be provided instead.

### INDUSTRIAL APPLICABILITY

The present invention is applicable to every image capturing device represented by the image capturing devices such as home video cameras and digital still cameras. With the present invention, by adjusting the gain of the column amplifier and limiting the output voltage depending on an image capture condition, a drive mode, etc., an image can be captured with reduced power-fluctuation-attributed noise, especially, streaks and transverse linear noise. It is thus possible to contribute to an enhancement in the quality of an image captured by the imaging devices.

1-26. (canceled)

27. A solid state imaging device switchable between a normal mode and a high-sensitivity mode, comprising:
a pixel array including pixel units arranged in rows and columns;
a row selecting unit configured to select one of the rows of said pixel array;
column amplifiers each of which is provided for a corresponding one of the columns and amplifies a column signal provided from said pixel unit included in the selected row; and
limiting circuits each of which limits an output voltage of a corresponding one of said column amplifiers to no more than a predetermined voltage that can be changed,
wherein said limiting circuit changes the predetermined voltage according to the switching between the normal mode and the high-sensitivity mode.

28. The solid state imaging device according to claim 27,
wherein each of said column amplifiers further changes a gain of said column amplifier upon the switching between the normal mode and the high-sensitivity mode.

29. The solid state imaging device according to claim 27,
wherein upon the switching between the modes, a gain of an amplifier circuit provided in a stage subsequent to said column amplifiers is changed.

30. The solid state imaging device according to claim 27,
wherein said limiting circuit is configured to, in the normal mode, supply each of said column amplifiers with a first voltage as a bias voltage for controlling the output voltage of said column amplifier, and in the high-sensitivity mode, supply each of said column amplifiers with a second voltage as the bias voltage so as to limit the output voltage of said column amplifier, the second voltage being different from the first voltage.

31. The solid state imaging device according to claim 30,
wherein said limiting circuit is configured to limit the output voltage of said column amplifier supplied with the first voltage as the bias voltage to no more than the predetermined voltage, and limit the output voltage of said column amplifier supplied with the second voltage as the bias voltage to no more than a voltage lower than the predetermined voltage, and
each of said column amplifiers further sets a gain of said column amplifier in the high-sensitivity mode to be higher than a gain of said column amplifier in the normal mode.

32. The solid state imaging device according to claim 31,
wherein a gain of an amplifier circuit in the high-sensitivity mode is set to be higher than a gain of said amplifier circuit in the normal mode, said amplifier circuit being provided in a stage subsequent to said column amplifiers.

33. The solid state imaging device according to claim 27,
wherein said limiting circuit includes a voltage clipping circuit which is connected to an output signal line of each of said column amplifiers and clips the output voltage of said column amplifier to the predetermined voltage when the output voltage is about to exceed the predetermined voltage.

34. The solid state imaging device according to claim 27,
wherein each of said column amplifiers includes a gain change circuit which changes a gain of said column amplifier.

35. The solid state imaging device according to claim 33,
wherein each of said column amplifiers includes a constant current source, an amplifying transistor, an input capacitive element, and a feedback capacitive element,
one of a source and a drain of said amplifying transistor is connected to said constant current source and outputs the output voltage to the output signal line,
the other one of the source and the drain of said amplifying transistor is grounded,
the column signal is input to a gate of said amplifying transistor via said input capacitive element,
one of terminals of said feedback capacitive element is connected to the gate of said amplifying transistor, and
the other one of the terminals of said feedback capacitive element is connected to the output signal line.

36. The solid state imaging device according to claim 35,
wherein said voltage clipping circuit includes a clipping transistor,
one of a source and a drain of said clipping transistor is connected to the gate of said amplifying transistor,
the other one of the source and the drain of said clipping transistor is connected to the output signal line, and
to a gate of said clipping transistor, a bias voltage that can be changed is input.

37. The solid state imaging device according to claim 36, further comprising
a bias generation circuit which generates the bias voltage and supplies the bias voltage to the gate of said clipping transistor,
wherein a level of the bias voltage is changed according to an external bias control signal.

38. The solid state imaging device according to claim 36,
wherein said constant current source includes a first constant current source transistor and a second constant current transistor which are cascode-connected to each other,
a constant voltage is input to a gate of said first constant current source transistor,
one of a source and a drain of said second constant current source transistor is connected to the output signal line, and
a gate of said second constant current source transistor is supplied with the bias voltage.

39. The solid state imaging device according to claim 38,
wherein said bias generation circuit includes a current mirror circuit including a reference circuit, a first circuit, and a second circuit,
said reference circuit generates a reference current for a current mirror,
said first circuit is included in the current mirror together with said reference circuit, and supplies the constant voltage to the gate of said first constant current source transistor,
said second circuit is included in the current mirror together with said reference circuit, and supplies the bias voltage to the gate of said second current source transistor, and
said second circuit changes the bias voltage by changing a mirror ratio.

40. The solid state imaging device according to claim 38,
wherein said reference circuit includes:
a constant current source circuit; and
a first load nMOS transistor having a drain and a gate that are shorted and a source that is ground, the drain being connected to said current source circuit, and
said second circuit includes:
a first pMOS transistor having a drain and a gate that are shorted and a source that is connected to a power line, the drain being connected to the gate of said clipping transistor and from which the bias voltage is provided;
a first switch transistor;
a first nMOS transistor having a drain connected to the drain of said first pMOS transistor via said first switch transistor, a gate connected to the drain of said first load nMOS transistor, and a source grounded;
a second switch transistor; and
a second nMOS transistor having a drain connected to the drain of said first pMOS transistor via said second switch transistor, a gate connected to the drain of said first load nMOS transistor, and a source connected,
an area of said first nMOS transistor has a different size from an area of said second nMOS transistor on a semiconductor board in which said solid imaging device is formed, and
said first switch transistor and said second switch transistor are controlled to change the mirror ratio, according to the bias control signal.

41. The solid state imaging device according to claim 34, further comprising
a column analog-digital conversion circuit which converts into a digital signal an analog signal provided from each of said column amplifiers.

42. A solid state imaging device switchable between a normal mode and a high-sensitivity mode, comprising:
a pixel array including pixel units arranged in rows and columns;
a row selecting unit configured to select one of the rows of said pixel array;
column amplifiers each of which is provided for a corresponding one of the columns and amplifies a column signal provided from said pixel unit included in the selected row; and
a bias generation circuit which supplies each of said column amplifies with a bias voltage for controlling an operation of said column amplifier,
wherein said bias generation circuit changes the bias voltage according to the switching between the normal mode and the high-sensitivity mode.

43. The solid state imaging device according to claim 42,
wherein each of said column amplifiers includes a voltage clipping circuit which is connected to an output signal line of said column amplifier and clips the output voltage of said column amplifier to the predetermined voltage when the output voltage is about to exceed the predetermined voltage, and
the predetermined voltage is determined according to the bias voltage.

44. A method for driving a solid state imaging device including: a pixel array including pixel units arranged in rows and columns; a row selecting unit configured to select one of the rows of the pixel array; and column amplifiers each of which is provided for a corresponding one of the columns and amplifies a column signal provided from the pixel unit included in the selected row, and having a normal mode and a high-sensitivity mode for capturing an image, said method comprising:
supplying, in the normal mode, each of the column amplifies with a first voltage as a bias voltage for controlling an output voltage of the column amplifier; and
supplying, in the high-sensitivity mode, each of the column amplifiers with a second voltage as a bias voltage so that an output voltage of the column amplifier is limited, the second voltage being different from the first voltage.

45. The method for driving a solid state imaging device according to claim 44,
wherein the output voltage of the column amplifier supplied with the first bias voltage is limited to no more than a predetermined voltage,
the output voltage of the column amplifier supplied with the second bias voltage is limited to no more than a predetermined voltage, and
a gain of the column amplifier is set to be higher in the high-sensitivity mode than in the normal mode.

46. The method for driving a solid state imaging device according to claim 45, wherein a gain of an amplifier circuit provided in a stage subsequent to the column amplifiers is set to be higher in the high-sensitivity mode than in the normal mode.
